(19) United States
(12) Patent Application Publication
(10) Pub. No.: US 2009/0040300 A1
(43) Pub. Date: Feb. 12, 2009

(54) Removably Mountable, Portable Vision System

(75) Inventor: Mark Scribner, Windsor, ME (US)

Correspondence Address: IP Authority, LLC;Ramraj Soundararajan, 4821A Eisenhower Ave, Alexandria, VA, 22304, US

(73) Assignee: Two Loons Trading Company, Winsdor, ME (US)

(21) Appl. No.: 11/834,410

(22) Filed: Aug. 6, 2007

(51) Int. Cl. H04N 7/18; B60Q 1/00; H04N 5/225; H04N 5/232

(52) U.S. Cl. 348/143; 340/435; 340/901; 348/148; 348/164; 348/211.2; 348/376; 348/E05.026

(57) ABSTRACT

A removably mountable, portable vision system, the portable vision system including a portable, auto-focusing camera, which is removably mountable to a surface, for capturing and transmitting video to a portable hand-held receiver where the video is displayed as an aid to the user. The system may be used in a variety of vehicle applications, such as attaching a snow plow or backing up and connecting a trailer hitch. The auto-focusing camera provides for quick installation by eliminating manual focusing of the camera by the user. In addition, the system utilizes a single wireless channel for data transmission, eliminating the need for the user to select a wireless channel before use. Finally, the receiver has normal and reverse image display modes of operation, enabling the system to provide the user with an optimal video image regardless of the mounting location of the camera and the current application of the system.

### BACKGROUND OF THE INVENTION

1. Field of Invention

The present invention relates generally to the field of wireless camera systems. More specifically, the present invention provides a removably mountable, portable vision system, the portable vision system including a portable, auto-focusing camera, which is removably mountable to a surface, for capturing and transmitting video wirelessly to a portable hand-held receiver, the receiver display the received video. Particularly, the system of the present invention will be discussed in the context of applications in which the system is used to aid the driver of a vehicle.

2. Discussion of Prior Art

Known portable vision systems that can be used to aid the driver of a vehicle suffer a few disadvantages as they can be large and cumbersome, difficult to set up, and cannot provide the user with mounting flexibility while still providing a video image that makes steering intuitive. U.S. patent application publication 2003/0234512 A1 provides real-time video images to a vehicle driver to aid in the connection of the trailer hitch. However, the system is unable to provide the driver with a video image that allows for intuitive steering of the vehicle for all possible camera mounting locations.

Another wireless video hitching system, from HitchAid, includes a removably mountable camera that wirelessly transmits video images to a monitor. However, the monitor is large and bulky, and must be plugged in to the vehicle's accessory power plug. The monitor size and the need for it to be plugged in to operate makes adjusting the field of view of the camera difficult as the user is generally unable to make changes to the camera's position while viewing the camera's field of view on the monitor. Additionally, the system is unable to provide the driver with a video image that allows for intuitive steering of the vehicle for all possible camera mounting locations

A third portable vision system, available from Northern Vision Technologies, provides a removably mountable camera that wireless communicates video images to a hand-held receiver. Once again, the system is unable to provide a video image that enables intuitive steering for all camera mounting locations. Additionally, the user must select one of four wireless channels for use during set up, and the system requires the driver to monitor the video display while manually adjusting the focus of the camera to ensure a clear video image is provided. These required steps increase the complexity and time spent setting up and troubleshooting the system.

While these systems do provide portable vision systems that include removably mountable cameras that wirelessly transmit video images to a display, there is a need for such a system that can provide the driver with the most useful video image, enabling intuitive steering of the vehicle, from any mounting location while also providing simple setup, and the convenience of a battery-powered, hand-held display. Whatever the precise merits, features, and advantages of the prior art is, none of them achieves or fulfills the purposes of the present invention.

### SUMMARY OF THE INVENTION

A removably mountable, portable vision system, the portable vision system including a portable, auto-focusing camera, which is removably mountable to a surface, for capturing and transmitting video to a portable hand-held receiver where the video is displayed as an aid to the user. The system may be used in a variety of vehicle applications, such as attaching a snow plow or backing up and connecting a trailer hitch. The auto-focusing camera provides for quick installation by eliminating manual focusing of the camera by the user. In addition, the system utilizes a single wireless channel for data transmission, eliminating the need for the user to select a wireless channel before use. Finally, the receiver has normal and reverse image display modes of operation, enabling the system to provide the user with an optimal video image regardless of the mounting location of the camera and the current application of the system.

### BRIEF DESCRIPTION OF THE DRAWINGS

FIG. 1a illustrates the system of the present invention.

FIG. 1b illustrates the camera of the present invention.

FIG. 1c illustrates the receiver of the present invention.

FIG. 2 illustrates a method of using the present invention.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

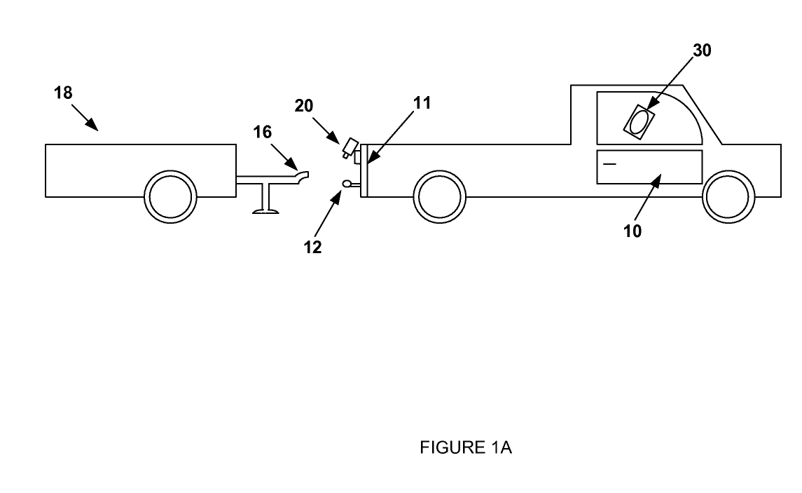

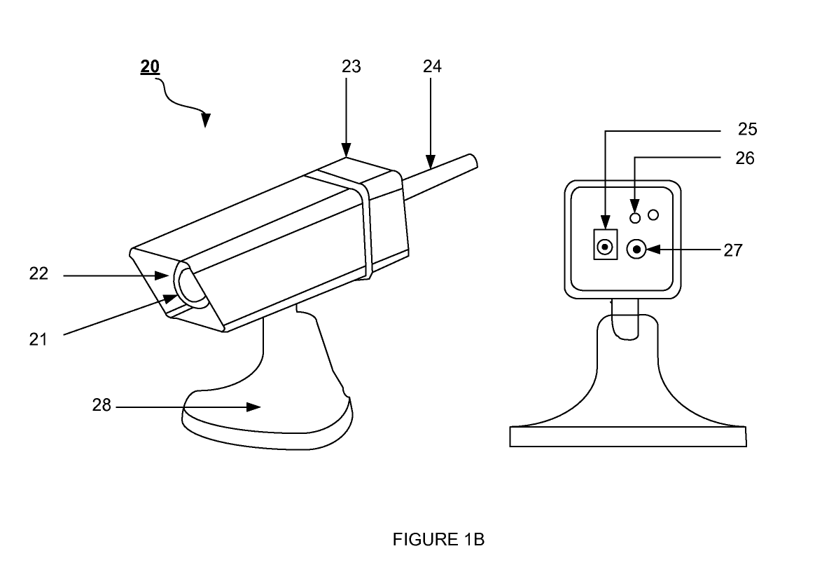

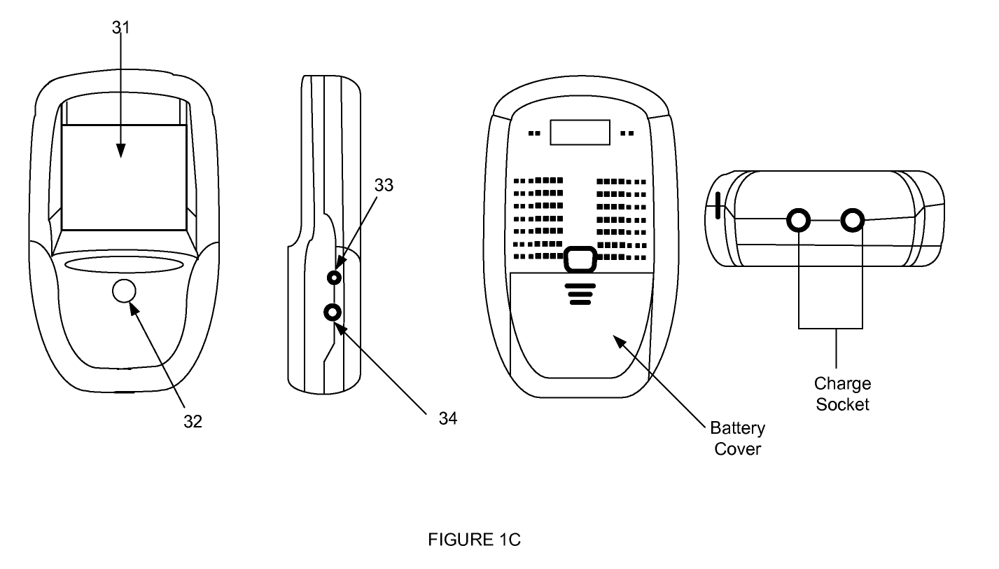

The removably mountable, portable vision system for aiding a driver of a vehicle in an exemplary embodiment and application is illustrated in FIG. 1A. As shown, the system comprises a camera 20 that is removably mounted to tailgate 11 of vehicle 10. The camera is positioned such that the field of view of the camera images tow hitch 12 of the vehicle, and the captured video is wirelessly transmitted to portable hand-held receiver 30 where it is displayed in real time. With the aid of the live video from camera 20, the driver of the vehicle is more easily able to back up and align tow hitch 12 of the vehicle with trailer hitch 16 of trailer 18. While the figure illustrates use of the invention in aiding a driver with attaching a trailer, the scope of the invention should not be limited to this exemplary application. For example, the portable vision system may be used to aid a driver in backing up into tight spaces, backing a boat into the water at a marina, or attaching a plow to the front of a truck. Indeed, many other applications for the system could be envisioned and the scope of the claimed invention should not be limited to any particular application. An additional feature of the present invention is the availability of both normal and reverse imaging modes and the ability to easily switch between the two imaging modes. When operating in the reverse imaging mode, the receiver displays a reflection of the image generated by the camera. The reverse image emulates the effect of a mirror, such as a rearview mirror of a vehicle. The driver may select either the normal or reverse imaging modes for use depending on the mounting location of the camera and the particular use of the system at that time, providing superior versatility to prior art systems.

The utility of the reverse imaging mode will be further explained in regards to the trailer hitch application of FIG. 1A. As shown, camera 20 is mounted to tailgate 11 of vehicle 10. In this arrangement, the camera is facing in the opposite direction as the driver, who is in the cab of vehicle 10 looking towards the front of the vehicle, such that objects to the left in the field of view of the camera are to the driver's right, and vice versa. In normal imaging mode, receiver 30 displays the video exactly as it is received from camera 20. If the trailer is located to the back and right of the driver, it will appear to the left in the video image of the camera displayed on the receiver. Viewing this image, the driver's natural instinct would be to turn the steering wheel to the left, resulting in the vehicle being steered away from the trailer hitch. In order to successfully back up the truck to the trailer, the driver would need to fight intuition and turn the steering wheel to the right. With reverse imaging mode, the video image provided by camera 20 is reflected before being displayed by receiver 30. With reverse imaging mode, a trailer located to the back and right of the vehicle would appear to the right in the video image displayed by the receiver, even though the trailer is to the left from the camera's perspective. Using the reverse image, the driver is able to intuitively steer the vehicle towards the trailer, much the same as backing up a vehicle using the vehicle's rearview mirror. In an alternative application, camera 20 is mounted to the front of vehicle 10 to aid the driver in approaching and attaching a snow plow. In this application, the camera and driver are facing in the same direction so an unaltered video image would be desirable, as steering the vehicle using a reverse image in this application would be unintuitive. As previously mentioned, the driver selects either the normal or reverse imaging mode, according to the location and orientation of camera 20, such that receiver 30 displays a video image that would enable the driver to intuitively steer the vehicle. The ability to easily switch between normal and reverse imaging modes as needed depending upon the orientation of the camera and the desired application gives the user tremendous flexibility in using the system. Prior art portable vision systems fail to anticipate or render obvious this capability.

FIG. 1B illustrates camera 20 in more detail. As shown, the camera comprises an auto-focusing lens 21, infrared LEDs 22, weatherproof cover 23, antenna 24, power jack 25, indicator LED 26, power on/off switch 27, and magnetic stand 28. Camera 20 further comprises a rechargeable battery power supply (not shown). The magnetic stand enables camera 20 to be removably mounted to vehicle 10 for use. In an alternative embodiment, a suction cup mount comprising three suction cups attached to a base plate may be used in mounting camera 20. Camera 20 is provided with means to enable the user to adjust the angle and direction of lens 21 in relation to stand 28 once it has been mounted. Many means for attaching the lens 21 and associated housing to the base such that the angle and direction of the lens is adjustable are known to those skilled in the art, hence further discussion of the adjustable attachment means has been omitted; however, it should be understood that the spirit and scope of the present invention should not be limited by any particular adjustable attachment means. Once mounted and turned on by actuation of power on/off switch 27, lens 21 is automatically focused, and video captured by the lens is wirelessly transmitted using antenna 24 to receiver 30 where it is displayed. A single wireless channel is used to communicate the video image data from the camera to the receiver, and therefore, the user is not burdened with selecting a wireless channel on the camera and the receiver or with checking that the same wireless channel is selected prior to use of the system. Infrared LEDs 22 provide a night vision mode that is automatically activated in low ambient light conditions. In night vision mode, the infrared light cast from the LEDs is reflected by objects in the surrounding environment and detected by the camera, providing the user with a clear image even in darkness. Power jack 25 provides a connection point for a battery charger, enabling recharging of rechargeable battery power supply. Indicator LED 26 provides indication of the current power state of camera, the power states including power off, power on, charging with power off, and charging with power on.

FIG. 1C illustrates receiver 30 in more detail. As shown, receiver 30 includes color liquid crystal display (LCD) 31, power on/off switch 32, indicator LED 33, power jack 34, and rechargeable battery power supply (not shown). LCD 31 displays the video received from camera 20. The receiver is switched on or off by pressing and holding power on/off switch 32 for three seconds. When the receiver is powered on, quickly pressing and releasing power on/off switch 32 serves to toggle the receiver between normal and reverse image modes. When operating in night vision mode, the LCD display is black and white instead of color. Power jack 34 provides a connection point for a battery charger, enabling recharging of rechargeable battery power supply. Indicator LED 33 provides indication of the current power state of receiver, the power states including power off, power on, charging with power off, charging with power on, and low battery.

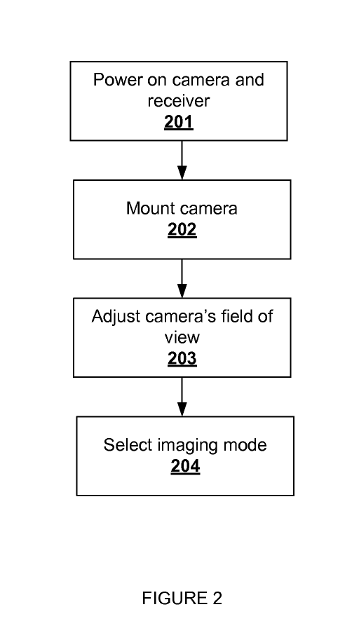

FIG. 2 illustrates a method of using the present invention. In step 201, the user powers on camera 20 by pressing power on/off switch 27 and likewise powers on receiver 30 by pressing and holding power on/off switch 32 for three seconds. In step 202, the user mounts the camera in the desired location and orientation. For example, if the user wants to use the system to aid in hitching a trailer, the user mounts the camera to the tailgate of the vehicle using magnetic stand 28. In step 203, the user adjusts the field of view of the camera using the image provided by the display. After the camera is mounted and the field of view adjusted, in step 204, the user selects the desired imaging mode by quickly pressing and releasing power on/off switch 32 of receiver 30. In the present case of hitching a trailer with the camera mounted to the vehicle tailgate, the user selects the reverse imaging mode, thereby causing the receiver to provide the reverse image which is more easily used in backing up the vehicle and aligning it with a trailer hitch.

### Conclusion

A system and method has been shown in the above embodiments for the effective implementation of a removably mountable, portable vision system. While various preferred embodiments and applications, particularly vehicle guiding applications, have been shown and described, it will be understood that there is no intent to limit the invention by such disclosure. In fact, the portable vision system may be used in a variety of non-vehicle related applications wherever the user needs an extra set of eyes. Rather, the invention disclosure is intended to cover all modifications and alternate constructions falling within the spirit and scope of the invention, as defined in the appended claims.

1. A removably mountable, portable vision system, the system comprising:
an auto-focusing portable camera that is removably mountable to a surface; and
a portable hand-held receiver including a display screen;
wherein the portable camera transmits video images wirelessly to the portable receiver;
wherein the receiver is switchable between normal and reverse imaging modes for display of received video images;
wherein when operating in reverse imaging mode, the video images received from the camera are reflected before being displayed.

2. The system of claim 1 wherein the camera comprises;
an auto-focusing lens;
an antenna;
a weatherproof cover;
a power on/off switch; and
a camera stand, wherein the camera stand is used to removably mount the camera to a surface.

3. The system of claim 2, wherein the camera stand comprises magnets for removably mounting the camera to a surface.

4. The system of claim 2, wherein the camera stand comprises suction cups for removably mounting the camera to a surface.

5. The system of claim 2 wherein the camera further comprises infrared LEDs enabling use of the system in low light and night time conditions.

6. The system of claim 2 wherein the camera further comprises:
a rechargeable battery power supply; and
a power jack;
wherein a battery charger is plugged in to the power jack to recharge the battery power supply of the camera.

7. The system of claim 2 wherein the camera further comprises an LED indicator.

8. The system of claim 7 wherein the camera LED indicator indicates an operating state of the camera, the operating states consisting of: power off; power on; charging with power off, and charging with power on.

9. The system of claim 1 wherein the display screen of the receiver is a liquid crystal display.

10. The system of claim 1 wherein the receiver further comprises a power on/off switch.

11. The system of claim 10 wherein the receiver further comprises:
a rechargeable battery power supply; and
a power jack;
wherein a battery charger is plugged in to the power jack to recharge the battery power supply of the receiver.

12. The system of claim 10 wherein the receiver further comprises an LED indicator.

13. The system of claim 12 wherein the receiver LED indicator indicates an operating state of the receiver, the operating states consisting of: power off; power on; charging with power off, charging with power on; and low battery.

14. A removably mountable, portable vision system, the system comprising:
an auto-focusing portable camera that is removably mountable to a surface; the camera comprising:
an auto-focusing lens;
an antenna;
a weatherproof cover;
a power on/off switch;
an LED indicator that indicates an operating state of the camera;
a rechargeable battery power supply;
a power jack for connecting a battery charger to the rechargeable battery power supply; and
a camera stand, wherein the camera stand is used to removably mount the camera to a surface; and
a portable hand-held receiver, the receiver comprising:
a liquid crystal display for displaying video images received from the camera;
a power on/off switch;
a rechargeable battery power supply;
a power jack for connecting a battery charger to the rechargeable battery power supply; and
an LED indicator that indicates an operating state of the receiver;
wherein the portable camera transmits a video signal wirelessly to the portable receiver;
wherein the receiver is switchable between normal and reverse imaging modes for display of received video images;
wherein when operating in reverse imaging mode, the video images received from the camera are reflected before being displayed.

15. The system of claim 14, wherein the camera stand comprises magnets for removably mounting the camera to a surface.

16. The system of claim 14, wherein the camera stand comprises suction cups for removably mounting the camera to a surface.

17. The system of claim 14 wherein the camera LED indicator indicates an operating state of the camera, the operating states consisting of: power off; power on; charging with power off, and charging with power on.

18. The system of claim 14 wherein the receiver LED indicator indicates an operating state of the receiver, the operating states consisting of: power off; power on; charging with power off, charging with power on; and low battery.

19. A method for using a removably mountable, portable vision system, the method comprising:
powering on an removably mountable, portable camera and a portable hand-held receiver;
mounting the removably mountable, portable camera;
adjusting the field of view of the camera with the aid of a video image displayed by the portable hand-held receiver; and
switching between normal and reverse imaging modes of operation as needed to select the imaging mode best suited for the position and orientation of the camera as well as the intended use of the system.
